(19) United States
(12) Patent Application Publication
(10) Pub. No.: US 2025/0257957 A1
(43) Pub. Date: Aug. 14, 2025

(54) INTERWOVEN HEAT EXCHANGER CORE WITH END FACE FEATURES

(71) Applicant: Hamilton Sundstrand Corporation, Charlotte, NC (US)

(72) Inventors: David Saltzman, Glastonbury, CT (US); Patrick McCord, Norwich, CT (US); Tung Le, Enfield, CT (US)

(21) Appl. No.: 18/438,907

(22) Filed: Feb. 12, 2024

(51) Int. Cl. F28F 9/22; B64D 13/06; F28F 27/02

(52) U.S. Cl. CPC F28F 9/22; B64D 13/06; F28F 27/02; B64D 2013/0618

(57) ABSTRACT

Heat exchangers include a housing with an internal structure that defines sets of first and second fluid passages such that a first fluid within the first fluid passages is prevented from mixing with a second fluid in the second fluid passages. An inlet manifold defines an inlet plenum for receiving the first fluid and directing the first fluid into openings of the first fluid passages. The openings are defined in an inlet end face of the internal structure within the inlet manifold. A set of flow directors are arranged on the inlet end face and are configured to direct a flow of the first fluid into the openings of the set of first fluid passages, with each flow director defining an end face passage that is one of the second fluid passages of the set of second fluid passages.

### BACKGROUND

The subject matter disclosed herein generally relates to heat exchangers and, more particularly, to heat exchangers having end faces features for improved operation.

Heat exchangers are utilized in various applications to exchange thermal energy between various fluid streams, such as between a first fluid stream and a second fluid stream. For example, in an aircraft environmental control system (ECS), a heat exchanger may be utilized to exchange thermal energy between a relatively low pressure, low temperature RAM airflow and a relatively high pressure, high temperature bleed air flow from a gas turbine engine compressor. Such thermal energy exchange may be provided to cool the bleed air flow upstream of an air cycle machine of the ECS prior to supplying treated air to an aircraft cabin or other volume or space onboard an aircraft.

In operation, heat exchangers are typically configured to transfer heat between a hot fluid and a cool fluid. To increase the efficiency of heat exchangers, primary surfaces (e.g., walls) and secondary surfaces (e.g., fins) are utilized to increase the surface area through which thermal energy can transfer. The heat transfer through a primary surface is typically very good because the primary surfaces (walls) are thin and the distance the thermal energy needs to travel is relatively small. However, the heat transfer through a secondary surface may be less efficient than through the primary surfaces because the thermal energy must travel a longer distance along the length of the secondary surface (fin). With conventional manufacturing techniques, the most compact heat exchangers (i.e., high surface area per unit volume) are achieved through increasing secondary surface area by adding fins rather than through the addition of primary surface area. As such, by reducing the size of the heat exchangers, the efficiency goes down due to the additional secondary surfaces.

To address this, interwoven, additively manufactured heat exchangers have been developed. The interwoven nature of such configurations can increase heat transfer while keeping the size and compactness of the heat exchanger low. Although such heat exchangers provide benefits over the wall-fin configurations, further improvements may be made to increase efficiency of heat exchangers.

### SUMMARY

According to some embodiments, heat exchangers are provided. The heat exchangers include a housing, an internal structure arranged within the housing, the internal structure defining a set of first fluid passages and a set of second fluid passages, wherein a first fluid within the set of first fluid passages is prevented from mixing with a second fluid in the set of second fluid passages, an inlet manifold at an inlet end of the set of first fluid passages and defining an inlet plenum for receiving the first fluid, wherein the set of first fluid passages comprise openings to the inlet plenum to receive the first fluid therethrough, wherein the openings of the set of first fluid passages are defined in an inlet end face of the internal structure, and a set of flow directors arranged on the inlet end face and configured to direct a flow of the first fluid into the openings of the set of first fluid passages, wherein each flow director defines an end face passage that is one of the second fluid passages of the set of second fluid passages.

In addition to one or more of the features described herein, or as an alternative, further embodiments of the heat exchangers may include an outlet manifold at an outlet end of the set of first fluid passages and defining an outlet plenum for receiving the first fluid, wherein the set of first fluid passages comprise outlet openings to the outlet plenum to direct the first fluid into the outlet plenum, wherein the outlet openings of the set of first fluid passages are defined in an outlet end face of the internal structure and a set of outlet flow directors arranged on the outlet end face and configured to direct a flow of the first fluid into the outlet plenum, wherein each flow director defines an end face passage that is one of the second fluid passages of the set of second fluid passages.

In addition to one or more of the features described herein, or as an alternative, further embodiments of the heat exchangers may include an inlet manifold at an inlet end of the set of second fluid passages and defining a second inlet plenum for receiving the second fluid, wherein the set of second fluid passages comprise openings to the second inlet plenum to receive the second fluid therethrough, wherein the openings of the set of second fluid passages are defined in a second inlet end face of the internal structure and a second set of flow directors arranged on the second inlet end face and configured to direct a flow of the second fluid into the openings of the set of second fluid passages, wherein each flow director defines an end face passage that is one of the first fluid passages of the set of first fluid passages.

In addition to one or more of the features described herein, or as an alternative, further embodiments of the heat exchangers may include that each flow director comprises an apex and two flow control surfaces that extend from the apex to the internal structure.

In addition to one or more of the features described herein, or as an alternative, further embodiments of the heat exchangers may include that the apex is rounded and the flow control surfaces are curved and convex as they extend to the internal structure.

In addition to one or more of the features described herein, or as an alternative, further embodiments of the heat exchangers may include that the apex is pointed and the flow control surfaces are curved and convex as they extend to the internal structure.

In addition to one or more of the features described herein, or as an alternative, further embodiments of the heat exchangers may include that the apex is pointed and the flow control surfaces are planar surfaces that extend to the internal structure to define a substantially triangular shape of the flow director.

In addition to one or more of the features described herein, or as an alternative, further embodiments of the heat exchangers may include that the end face passage is similar in geometry to all other passages of the set of second fluid passages.

In addition to one or more of the features described herein, or as an alternative, further embodiments of the heat exchangers may include that the set of first fluid passages and the set of second fluid passages are defined within an interwoven structure of the internal structure within the housing.

In addition to one or more of the features described herein, or as an alternative, further embodiments of the heat exchangers may include that the first fluid is bleed air from an aircraft engine and the second fluid is RAM air from a RAM air duct of an aircraft.

According to some embodiments, methods of manufacturing heat exchangers are provided. The methods include providing a housing, arranging an internal structure within the housing, the internal structure defining a set of first fluid passages and a set of second fluid passages, wherein a first fluid within the set of first fluid passages is prevented from mixing with a second fluid in the set of second fluid passages, wherein the housing defines an inlet manifold at an inlet end of the set of first fluid passages and defining an inlet plenum for receiving the first fluid, wherein the set of first fluid passages comprise openings to the inlet plenum to receive the first fluid therethrough, wherein the openings of the set of first fluid passages are defined in an inlet end face of the internal structure, and forming a set of flow directors on the inlet end face and configured to direct a flow of the first fluid into the openings of the set of first fluid passages, wherein each flow director defines an end face passage that is one of the second fluid passages of the set of second fluid passages.

In addition to one or more of the features described herein, or as an alternative, further embodiments of the methods may include that an outlet manifold is defined by the housing at an outlet end of the set of first fluid passages and defining an outlet plenum for receiving the first fluid, wherein the set of first fluid passages comprise outlet openings to the outlet plenum to direct the first fluid into the outlet plenum, wherein the outlet openings of the set of first fluid passages are defined in an outlet end face of the internal structure, and forming a set of outlet flow directors on the outlet end face and configured to direct a flow of the first fluid into the outlet plenum, wherein each flow director defines an end face passage that is one of the second fluid passages of the set of second fluid passages.

In addition to one or more of the features described herein, or as an alternative, further embodiments of the methods may include that an inlet manifold is defined by the housing at an inlet end of the set of second fluid passages and defining a second inlet plenum for receiving the second fluid, wherein the set of second fluid passages comprise openings to the second inlet plenum to receive the second fluid therethrough, wherein the openings of the set of second fluid passages are defined in a second inlet end face of the internal structure and forming a second set of flow directors on the second inlet end face and configured to direct a flow of the second fluid into the openings of the set of second fluid passages, wherein each flow director defines an end face passage that is one of the first fluid passages of the set of first fluid passages.

In addition to one or more of the features described herein, or as an alternative, further embodiments of the methods may include that each flow director comprises an apex and two flow control surfaces that extend from the apex to the internal structure.

In addition to one or more of the features described herein, or as an alternative, further embodiments of the methods may include that the apex is rounded and the flow control surfaces are curved and convex as they extend to the internal structure.

In addition to one or more of the features described herein, or as an alternative, further embodiments of the methods may include that the apex is pointed and the flow control surfaces are curved and convex as they extend to the internal structure.

In addition to one or more of the features described herein, or as an alternative, further embodiments of the methods may include that the apex is pointed and the flow control surfaces are planar surfaces that extend to the internal structure to define a substantially triangular shape of the flow director.

In addition to one or more of the features described herein, or as an alternative, further embodiments of the methods may include that the end face passage is similar in geometry to all other passages of the set of second fluid passages.

In addition to one or more of the features described herein, or as an alternative, further embodiments of the methods may include that the set of first fluid passages and the set of second fluid passages are defined within an interwoven structure of the internal structure within the housing.

In addition to one or more of the features described herein, or as an alternative, further embodiments of the methods may include that the housing and the internal structure are additively manufactured as a single structure.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a perspective view of an embodiment of a heat exchanger that may incorporate embodiments of the present disclosure;

FIG. 2A is a cross-sectional schematic illustration of a heat exchanger in accordance with an embodiment of the present disclosure;

FIG. 2B is an enlarged illustration of a detail of an internal structure of the heat exchanger of FIG. 2A;

FIG. 2C is another view of the detail of FIG. 2B, showing an internal feature thereof;

FIG. 2D is an enlarged cross-sectional view of a portion of the internal structure of FIG. 2A;

FIG. 3A is a schematic illustration of flow at an end face of a heat exchanger in accordance with an embodiment of the present disclosure;

FIG. 3B is a schematic illustration of a flow at an end face of a heat exchanger without features in accordance with the present disclosure;

FIG. 4A is a first example of an end face structure and flow director in accordance with an embodiment of the present disclosure;

FIG. 4B is a second example of an end face structure and flow director in accordance with an embodiment of the present disclosure;

FIG. 4C is a third example of an end face structure and flow director in accordance with an embodiment of the present disclosure;

FIG. 5A is a side elevation cross-sectional illustration of a heat exchanger in accordance with an embodiment of the present disclosure; and

FIG. 5B is a plan view cross-sectional illustration of the heat exchanger of FIG. 5A.

### DETAILED DESCRIPTION

As shown and described herein, various features of the disclosure will be presented. Various embodiments may have the same or similar features and thus the same or similar features may be labeled with similar reference numerals and/or description thereof may be omitted in certain later described embodiments for conciseness. Although similar reference numbers may be used in a generic sense, various embodiments will be described and various features may include changes, alterations, modifications, etc. as will be appreciated by those of skill in the art, whether explicitly described or otherwise would be appreciated by those of skill in the art. Further, it will be appreciated that, unless otherwise stated, features from the various separately described embodiments may be combined in various combinations and each embodiment is not intended to be mutually exclusive from features of other embodiments described herein and/or mutually exclusive from other features and components not explicitly described.

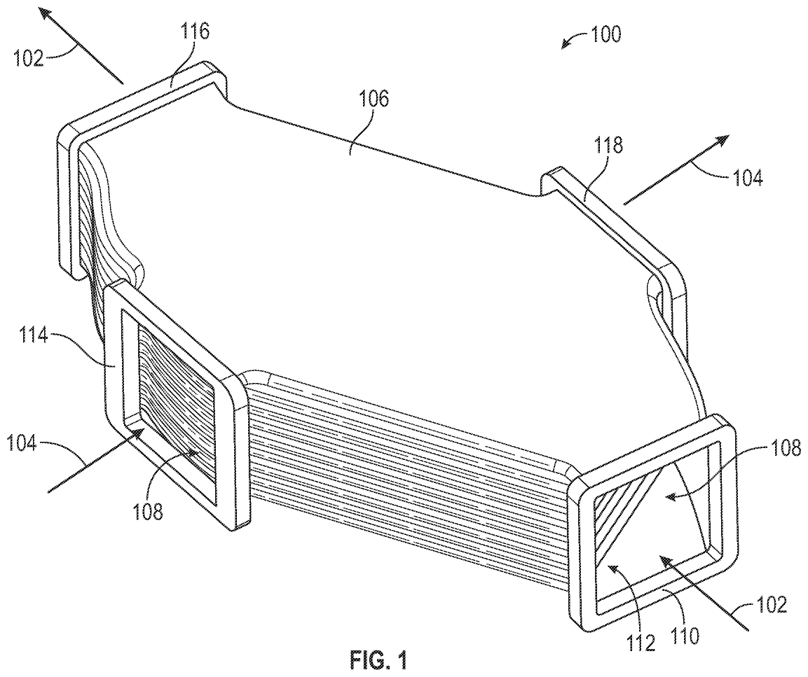

Referring to FIG. 1, illustrated is a schematic view of an embodiment of a heat exchanger 100 that may incorporate embodiments of the present disclosure. The heat exchanger 100 is configured to facilitate an exchange of thermal energy between a first fluid flow 102 and a second fluid flow 104 directed through the heat exchanger 100. In a non-limiting example application, the first fluid flow 102 is a relatively high temperature, high pressure fluid flow such as a bleed airflow from a compressor of a gas turbine engine, and the second fluid flow 104 is a relatively low temperature, low pressure fluid flow such as RAM airflow for use by an aircraft environmental control system (not shown). In some configuration, the heat exchanger 100 may be arranged within a RAM air duct or the like. In other configurations, the heat exchanger 100 may be part of an air cycle machine, part of a RAM air circuit, part of an environmental control system, part of a closed-loop supercritical fluid system, or may be used as a heat exchanger in any thermal exchange system onboard an aircraft. Accordingly, the fluids passing through the heat exchanger 100 may include, but are not limited to, air (from various sources), oil, water, CO₂, sCO₂, fuel, coolant, refrigerant, or the like, as will be appreciated by those of skill in the art.

The heat exchanger 100 has a housing 106 that contains internal structures 108 that define a first fluid path for the first fluid flow 102 and a second fluid path for the second fluid flow 104. The internal structures 108 are configured to prevent mixing of the two fluids while permitting thermal exchange and transfer from one of the first and second fluid flows 102, 104 to the other of the first and second fluid flows 102, 104.

The first fluid flow 102 enters the heat exchanger 100 at a first inlet manifold 110 which may include a manifold cavity 112 in which the fluid of the first fluid flow 102 is separated and distributed into the internal structures 108 along a first fluid flow structure. The second fluid flow 104 enters the heat exchanger 100 at a second inlet manifold 114 which may include a manifold cavity in which the fluid of the second fluid flow 104 is separated and distributed into the internal structures 108 along a second fluid flow structure. The first and second fluid flow structures of the internal structures 108 may be arranged as interwoven flow paths, such as shown and described in commonly owned U.S. Pat. No. 10,890,381, entitled Cross-flow Heat Exchanger, the contents of which are incorporated herein in their entirety. As the first fluid flow 102 and the second fluid flow 104 pass through the respective fluid flow structures of the internal structures 108 of the heat exchanger 100, thermal exchange between the two fluids may occur. The first fluid flow 102 will then exit through a first outlet manifold 116 and the second fluid flow 104 will exit through a second outlet manifold 118.

The heat exchanger 100 is a crossflow heat exchanger such that as the first and second fluid flows 102, 104 pass through the heat exchanger 100, the two flows are flowing in substantially normal directions relative to each other. Although illustrated as a crossflow heat exchanger in FIG. 1, embodiments of the present disclosure are not limited to such heat exchanger configurations. In other configurations, the two flows may be counter flow or parallel flow, depending on the specific application and/or arrangement of the structure of the heat exchanger.

The weave heat exchanger design is an additively manufactured heat exchanger with an interwoven passage geometry. The discrete channels of the two fluid circuits weave around each other to augment heat transfer and ensure that the fluid in each fluid passage is in constant contact with the flow path of the other fluid to maximize thermal exchange therebetween. Although such interwoven configurations may provide improvements and increased efficiencies as compared to a wall/fin arrangement, losses may still occur due to various features thereof.

Fluid pressure losses may occur as a consequence of forcing the fluid(s) through the internal structures of the heat exchanger. Typically, the fluid passages defined by the internal structures of the heat exchanger are smaller in cross-section than a flow path supplying the fluid into the heat exchanger. As a result, the fluid is forced into smaller (although greater in number) fluid passages, which can result in losses. Further, the inlet and exit faces of the internal structures of the heat exchanger may be flat in order to define an inlet/outlet plenum within a manifold. As the fluid enters the inlet of the internal structures, the fluid is contracted, and as the fluid exits the outlet of the internal structures, the fluid is expanded. The flat surfaces at the inlet and/or outlet may cause a fluid flow stagnation region to form. Such stagnation of fluid can cause increased pressure losses at the inlet and outlet of the heat exchanger.

Accordingly, in accordance with some embodiments of the present disclosure, the inlet and/or outlet facing ends of the internal structures of the heat exchanger may be modified to improve flow contraction and expansion into the heat exchanger passages on one or more heat exchanger flow circuits. The added feature(s) allows for a more fluid-dynamic face of the heat exchanger without removing/reducing surface area or greatly impacting weight. Such features may be particularly impactful at an inlet end, where a fluid flows and contacts directly with an end face of the internal structures. At the outlet end, such features may be provided to reduce turbulence as the fluid exits the internal structures and is rejoined within an outlet manifold cavity or otherwise at the outlet of the flow path as it exits the heat exchanger.

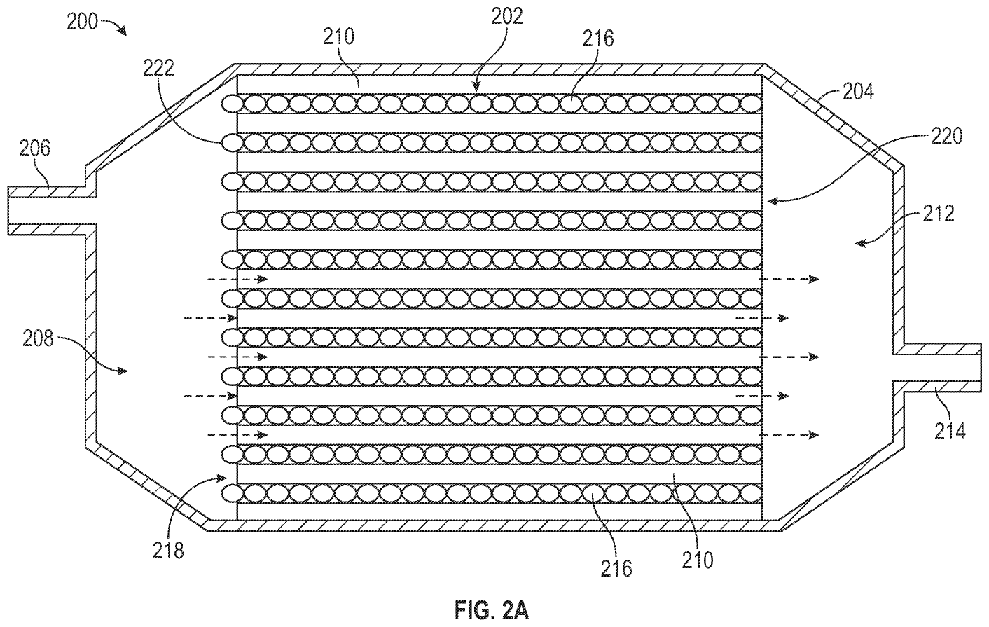

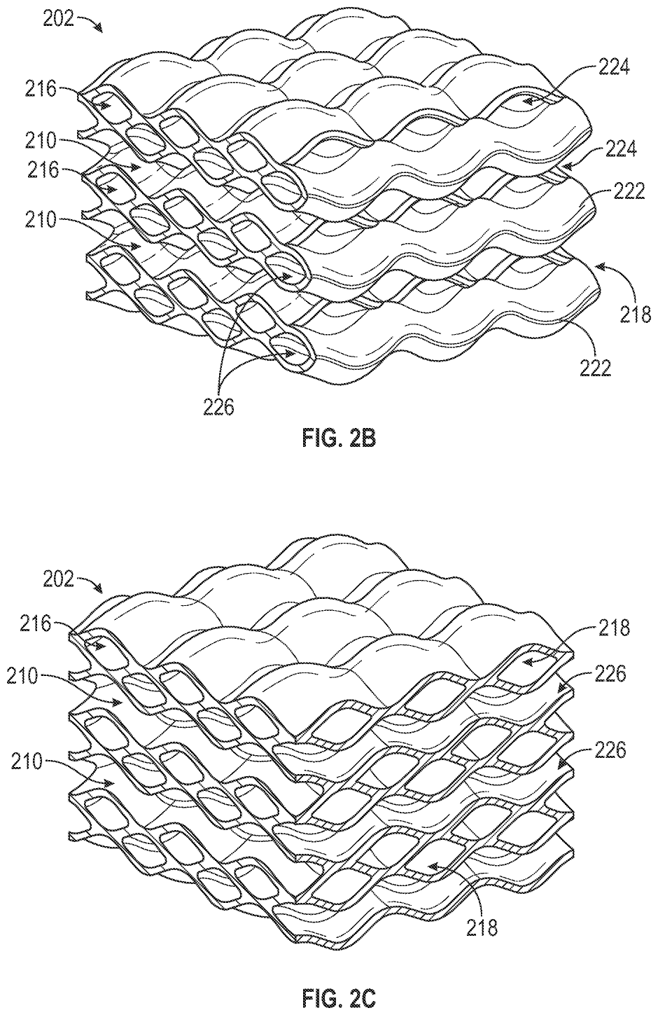

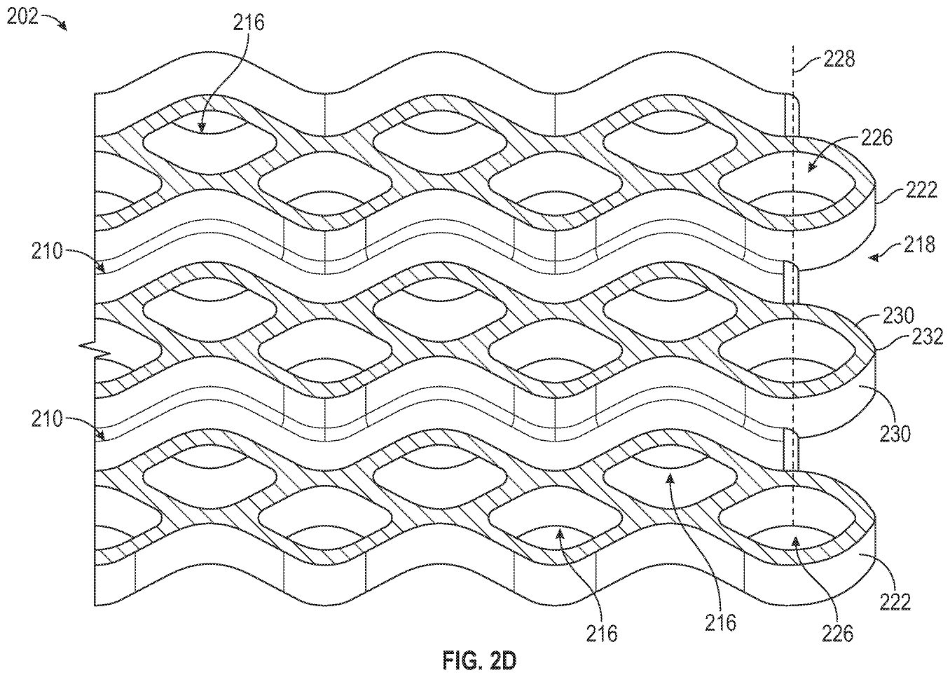

Referring now to FIGS. 2A-2D, schematic illustrations of a heat exchanger 200 having an internal structure 202 in accordance with an embodiment of the present disclosure are shown. The heat exchanger 200 includes a housing 204 that contains the internal structure 202. The housing 204 defines an internal volume that contains the internal structure 202 and is configured to receive at least two different fluids for heat exchange therebetween. FIG. 2A illustrates a schematic side cross-sectional view of the arrangement of the internal components of the heat exchanger 200, with FIGS. 2B-2D providing more illustrative detail of the internal structure 202. That is, the illustrative of FIG. 2A is merely schematic and is provided for explanation and is merely schematically shown, and the more detailed structural views are provided in FIGS. 2B-2D. The internal structure 202 may be a tube bank, interwoven arrangement, or the like, with sets of fluid passages extending at angles relative to each other. In the illustrative embodiments, the angle of origination is substantially normal or about 90°.

The housing 204 has an inlet 206 that provides fluid communication into an inlet manifold 208 which defines an inlet plenum for receiving a first fluid through the inlet 206. The first fluid will then enter and flow through a plurality of first fluid passages 210. The first fluid passages 210 extend from the inlet manifold 208 to an outlet manifold 212 which defines an outlet plenum where the first fluid exits the first fluid passages 210. The first fluid will then exit the heat exchanger 200 through an outlet 214. As shown, second fluid passages 216 are provided as a set of passages that extend perpendicular or normal to the flow direction through the first fluid passages 210. Although not shown in this view, it will be appreciated that a cross-sectional view looking along a flow direction through the second fluid passages 216 may appear substantially similar to that illustrated in FIG. 2B, with an associated inlet, inlet manifold, outlet, and outlet manifold provided within the internal structure 202. As such, the heat exchanger 200 may be a crossflow heat exchanger, as will be appreciated by those of skill in the art.

The heat exchanger internal structure 202 is arranged with an interwoven geometry, as shown in more detail in FIGS. 2B-2D, to form the crossflow heat exchanger configuration. Within the heat exchanger internal structure 202, the first fluid passages 210 define a first fluid path or flow path and the second fluid passages 216 define a second fluid path or flow path. As shown, the first fluid passages 210 are arranged in parallel and, similarly, the second fluid passages 216 are arranged in parallel. The first fluid passages 210 extend from an inlet end 218 at the inlet manifold 208 to an outlet end 220 at the outlet manifold 212.

As shown in FIG. 2A, and described in more detail herein, the inlet end 218 of the first fluid passages 210 are defined with end face features in the form of flow directors 222 provided about an inlet into each first fluid passage 210. The flow directors 222 are structural features that extend into the plenum of the first manifold 208 and may be fluid and/or aerodynamically configured to aid in directing a flow of the first fluid into the first fluid passages 210. In this illustrative configuration shown in FIG. 2A, the outlet end 220 of the first fluid passages 210 is not provided with such end face features. However, in other embodiments, the outlet end 220 may also include end face features similar to that of the inlet end 218. Furthermore, it will be appreciated that the inlet and outlet ends of the second fluid passages 216 may also be similarly provided with end face features, as shown and described herein.

Referring now to FIGS. 2B-2D, more detailed schematic illustrations of the arrangement of the internal structure 202 are shown. FIG. 2B is a perspective view of a portion of the internal structure 202 of the heat exchanger 200 having flow directors 222, in accordance with an embodiment of the present disclosure. FIG. 2C is a similar perspective view, illustrating the internal structure 202 without the flow directors 222 shown for illustrative and explanatory purposes regarding the internal structure of the flow directors 222. FIG. 2D is a cross-sectional illustration of a portion of the internal structure 202 of the heat exchanger 200.

As shown in FIGS. 2B-2D, the internal structure 202 has an interwoven configuration of the first fluid passages 210 and the second fluid passages 216. At the inlet end 218, the first fluid passages 210 have inlets 224 defined between the flow directors 222. The flow directors 222 are defined by one of the second fluid passages 216, with such end face second fluid passages within the flow directors 222 referred to herein as end face passages 226. The end face passages 226 are flow paths for the second fluid, but are arranged such that a portion of the material or walls defining the end face passages 226 extends outward from an end face 228 of the internal structure 202, as shown in FIG. 2D. The flow directors 222, having the end face passages 226 of the second fluid passages 216 defined therein, are arranged to guide and direct a flow of the first fluid into the inlets 224 of the first fluid passages 210. As a results, the flow of the first fluid as it enters the first fluid passages 210 may not become turbulent. Accordingly, fewer pressure losses may occur as the first fluid flows into and through the first fluid passages 210.

As shown in FIG. 2D, the end face passages 226 which extend through the flow directors 222 are defined with an extension of material that extends beyond the end face 228 of the internal structure 202. The flow directors 222 are defined with flow control surfaces 230 that join at an apex 232 such that the inlet 218 of a first fluid passage 210 is defined between two adjacent flow directors 222, with the flow control surfaces 230 directing a flow of fluid into the respective first fluid passage 210. The apex 232 may be pointed or curved, but is generally arranged such that an incoming flow will smoothly divide at the apex 232 and travel along the flow control surfaces 230. The flow control surfaces 230 may be curved (e.g., as shown in FIGS. 2B-2D), or may be straight walls (e.g., substantially triangular in cross-section). Thus, a divided flow will be directed into first fluid passages 210 in a smooth and non-turbulent manner. The geometry of the flow directors 222 may reduce contraction losses (at the inlet) or expansion losses (at the outlet), depending on which end of the flow passages the flow directors 222 are arranged.

The internal structure 202 may be formed through various known means. In some embodiments, the internal structure 202, as shown, is an interwoven structure that may be additively manufactured. In other embodiments, the features shown and described herein may be implemented on a tube assembly configuration, where the first and second flow paths are substantially straight through tubes configured in a crossflow arrangement. The internal structure 202 may be formed from various thermally conductive materials, including, but not limited to, aluminum and/or steel. In some embodiments, the internal structure may be formed from the same material as the housing in which it is installed (or integrally formed with in some cases of additive manufacturing) or may be formed from a different material than the housing.

It will be appreciated that any crossflow heat exchanger arrangement may incorporate embodiments of the present disclosure. Furthermore, although shown as a crossflow heat exchanger arrangement, it will be appreciated that other types of flow arrangements of heat exchangers may incorporate embodiments of the present disclosure. For example, and without limitation, heat exchangers having multi-pass flow arrangements, counter flow arrangements, parallel flow arrangements, and/or multi-circuit flow arrangements may each incorporate the structures and features described herein, and the present disclosure is not intended to be limited to crossflow heat exchanger configurations, but rather such illustrations and description are for illustrative and explanatory purposes. Furthermore, with any type of heat exchanger, the fluid passages of one fluid flow may be fluidly separated from the fluid passages of the other fluid flow and mixing thereof is prevented. As noted, the sets of fluid passages may be angled relative to each other to provide for a crossflow configuration. The particular angle of one set of fluid passages relative to the other may be any angle that may be governed by thermal exchange considerations, fluid type, requirements for sizing, flow requirements, arrangement of fluid passages that supply the fluids into the inlet manifolds or receive the fluids from the outlet manifolds, or the like. In some configurations, the sets of fluid passages may be arranged parallel to each other, with separate inlet/outlet headers and supply of fluids into the respective passages. In such configurations, the inlet and outlet manifolds may include end faces with flow director features as shown and described herein. As such, an angle my not exist between the individual fluid passages within the internal structure, but rather the fluid separation and directions may be governed by the arrangement of the inlet and/or outlet manifolds, as will be appreciated by those of skill in the art.

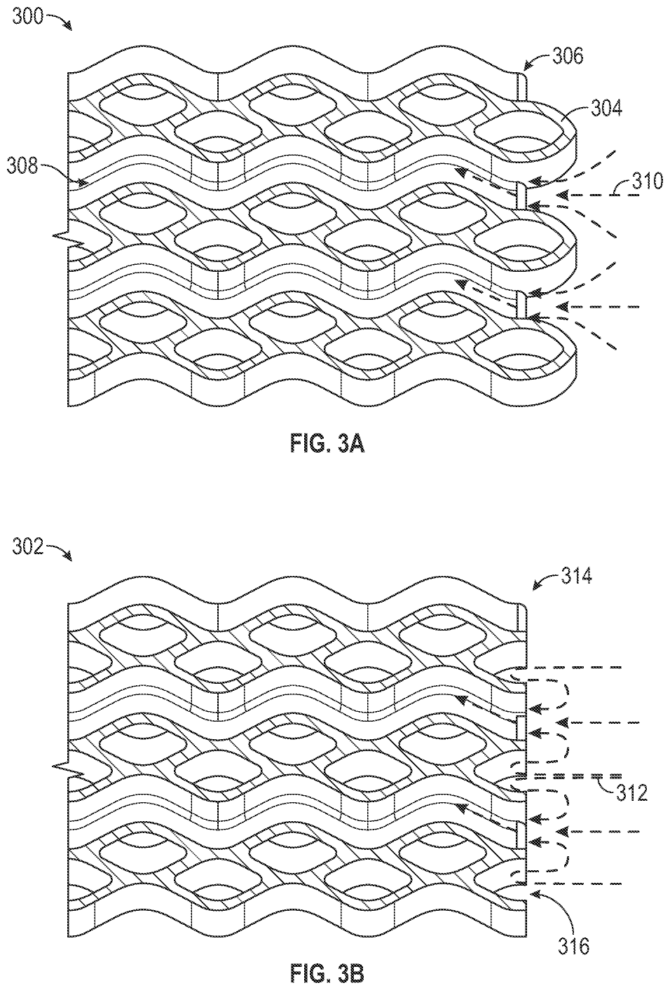

Referring now to FIGS. 3A-3B, an illustrative comparison of flow between a first heat exchanger internal structure 300 in accordance with an embodiment of the present disclosure (FIG. 3A) and a second heat exchanger internal structure 302 without features as described herein (FIG. 3B) is provided. The general structure of the two internal structures 300, 302 are similar, having interwoven fluid passages arranged in an interwoven fashion. However, the first internal structure 300 of FIG. 3A includes flow directors 304 arranged at the inlet end 306 of first fluid passages 308, similar to that shown and described with respect to FIGS. 2A-2D. In contrast, the second internal structure 302 shown in FIG. 3B does not include such flow directors.

As shown in FIG. 3A, the flow directors 304 provide a smooth transition of a fluid 310 as it enters the first fluid passages 308. In contrast, in the configuration of FIG. 3B, a fluid 312 will interact with an end face 314 of the internal structure 302 and result in turbulent flow 316 and associated losses.

The flow directors described herein, which may be applied to the inlet and outlet faces of the heat exchanger, will reduce component-level pressure losses while minimally impacting weight and heat transfer. With reduced pressure losses, a more aggressive core geometry can be used in the heat exchanger to increase overall heat rejection and/or thermal exchange. Furthermore, in the case of small heat exchangers, the inlet and outlet losses can be substantial, and, thus, the described flow directors arranged at the end faces of the internal structures of the heat exchangers can provide large performance benefits. It will be appreciated that a small heat exchanger is one that has a relatively small passage flow length compared with a passage size (e.g., a length-to-size ratio of about 10 or less). As such, the frictional losses in the channel passage will be the same order of magnitude as the expansion and contraction losses. This results in a heat exchanger that has a relatively short passage length has large percentage of pressure loss from contraction and expansion because of the low value of its length-to-size ratio. In many aerospace applications it may be required to have small heat exchangers due to physical size constraints in aircraft. Consequently, expansion and contraction losses across many components will add up quickly and degrade system performance. The flow directors of the present disclosure can decrease such losses even with a relatively short passage length and/or relatively small heat exchanger. For example, and without limitation, by incorporating the flow directors at the end faces of a heat exchanger internal structure, inlet and/or outlet losses may be improved (decreased) by 10% to 50% as compared to an internal structure without such flow directors.

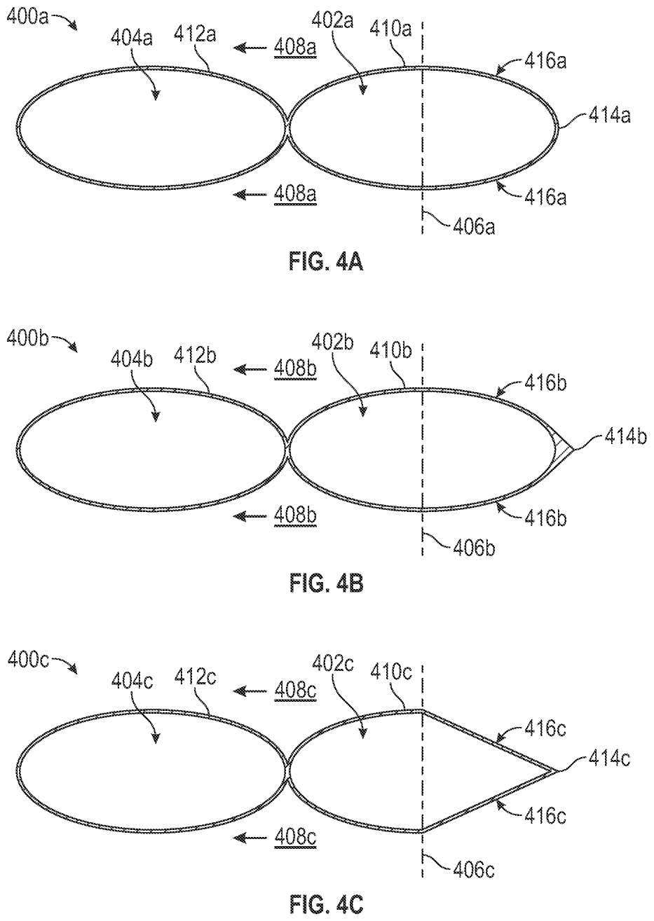

As noted above, the flow directors of the present disclosure may have a geometry to provide a smooth flow transition for fluids entering a flow path of a heat exchanger. Referring to FIGS. 4A-4C, schematic illustrations of examples of the geometries that may be employed for the flow directions are shown.

FIG. 4A illustrates a portion of a heat exchanger internal structure 400a having a first flow passage 402a and a second flow passage 404a. The first flow passage 402a is arranged at an end face 406a of the internal structure 400a and the second flow passage 404a is arranged downstream or behind the first flow passage 402a relative to a flow of a first fluid 408a. A second fluid may be directed through the first and second flow passage 402a, 404a, which may be normal to the flow direction of the first fluid 408a (i.e., in/out of the page of FIG. 4A). The first flow passage 402a is an end face passage that extends through a flow director structure 410a, and the second flow passage 404a is an internal flow structure 412a arranged downstream from the flow director structure 410a with respect to the flow of the first fluid 408a. In this configuration, the flow director structure 410a has an apex 414a with flow control surfaces 416a that join at the apex 414a. The apex 414a and the flow control surfaces 416a, in this configuration, define a substantially oval or curved geometry with the apex 414a providing a substantially continuous and smooth transition between the flow control surfaces 416a.

FIG. 4B illustrates a portion of a heat exchanger internal structure 400b having a first flow passage 402b and a second flow passage 404b. The first flow passage 402b is arranged at an end face 406b of the internal structure 400b and the second flow passage 404b is arranged downstream or behind the first flow passage 402b relative to a flow of a first fluid 408b. A second fluid may be directed through the first and second flow passage 402b, 404b, which may be normal to the flow direction of the first fluid 408b (i.e., in/out of the page of FIG. 4B). The first flow passage 402b is an end face passage that extends through a flow director structure 410b, and the second flow passage 404b is an internal flow structure 412b arranged downstream from the flow director structure 410b with respect to the flow of the first fluid 408b. In this configuration, the flow director structure 410b has an apex 414b with flow control surfaces 416b that join at the apex 414b. The apex 414b and the flow control surfaces 416b, in this configuration, define a pointed geometry with the apex 414b providing a dividing surface to split an incoming flow of the first fluid 408b along the flow control surfaces 416b. The flow control surfaces 416b in this configuration are curved or bowed (convex) and thus define a curved surface along which the first fluid 408b may travel as it enters flow paths on opposite sides of the flow director structure 410b.

FIG. 4C illustrates a portion of a heat exchanger internal structure 400c having a first flow passage 402c and a second flow passage 404c. The first flow passage 402c is arranged at an end face 406c of the internal structure 400c and the second flow passage 404c is arranged downstream or behind the first flow passage 402c relative to a flow of a first fluid 408c. A second fluid may be directed through the first and second flow passage 402c, 404c, which may be normal to the flow direction of the first fluid 408c (i.e., in/out of the page of FIG. 4C). The first flow passage 402c is an end face passage that extends through a flow director structure 410c, and the second flow passage 404c is an internal flow structure 412c arranged downstream from the flow director structure 410c with respect to the flow of the first fluid 408c. In this configuration, the flow director structure 410c has an apex 414c with flow control surfaces 416c that join at the apex 414c. The apex 414c and the flow control surfaces 416c, in this configuration, define a substantially triangular geometry with the apex 414c being a pointed geometry that extends axially (in a direction of flow of the first fluid 408c) along substantially planar surfaces.

It will be appreciated that the geometries illustrated in FIGS. 4A-4C are for example purposes, and other geometries and arrangements may be employed with out departing from the scope of the present disclosure. Furthermore, in some embodiments, a single heat exchanger internal structure may include multiple different types of geometries on the end face thereof. For example, triangular geometries may be used for mid-portion locations, whereas a curved geometry may be used close to walls of a manifold or the like (or vice versa), or other combinations may be used without departing from the scope of the present disclosure. Various other geometries may be used that are arranged to direct and/or scoop flow in a smooth manner to reduce stagnation and/or pressure losses. Furthermore, although shown with the flow director structure arranged at an inlet end of a flow path of a heat exchanger, it will be appreciated that similar structures may be provided at the outlet of such flow paths and/or at both the inlet and the outlet of such flow paths. When provided at the outlet, a smooth flow transition of the conditioned fluid mixing in an outlet manifold may be achieved.

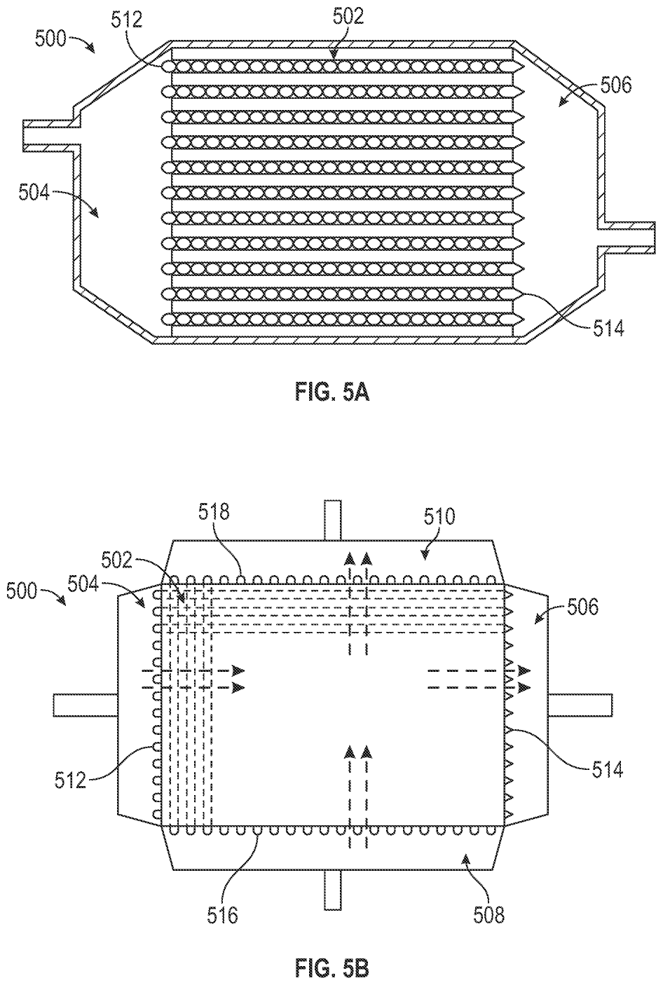

Referring now to FIGS. 5A-5B, schematic illustrations of a heat exchanger 500 in accordance with an embodiment of the present disclosure are shown. The heat exchanger 500 includes an internal structure 502 formed of internal fluid passages, such as shown and described above. A first set of fluid passages, within the internal structure 502, extends in a fluid flow direction from a first inlet manifold 504 to a first outlet manifold 506. A second set of fluid passages, within the internal structure 502, extends in a fluid flow direction from a second inlet manifold 508 to a second outlet manifold 510. As illustrated, the first set of fluid passages includes first inlet flow directors 512 arranged on a first inlet end face of the internal structure 502 within the first inlet manifold 504 and first outlet flow directors 514 arranged on a first outlet end face of the internal structure 502 within the first outlet manifold 506. Similarly, the first set of fluid passages includes second inlet flow directors 516 arranged on a second inlet end face of the internal structure 502 within the second inlet manifold 508 and second outlet flow directors 518 arranged on a second outlet end face of the internal structure 502 within the second outlet manifold 510. As shown, the flow directors 512, 514 of the first set of fluid passages have different geometries, with the first inlet flow directors 512 having rounded or curved geometries whereas the first outlet flow directors 514 have triangular or pointed geometries. In contrast, as shown, the flow directors 516, 518 of the second set of fluid passages have the same geometries (i.e., both rounded/curved). It will be appreciated that other configurations where all flow directors are the same or each is different from the other, or combinations thereof, may be employed without departing from the scope of the present disclosure.

Advantageously, embodiments of the present disclosure provide for improved heat exchangers with improved pressure loss controls. In accordance with some embodiments of the present disclosure, a modification is made to the inlet and/or outlet end faces of the heat exchanger to reduce component-level pressure losses while minimally impacting weight and heat transfer. Advantageously, with reduced pressure losses, a more aggressive core geometry can be used in the heat exchanger to increase overall heat rejection. The inlet and outlet losses can be substantial for small heat exchangers and the proposed geometry modifications can provide large performance benefits as compared to small heat exchangers that do not include such end face features. For example, in typical heat exchanger configurations, the end faces are flat and can cause fluid flow stagnation. The stagnation of the fluid causes increased pressure losses at the inlet and outlet, whereas embodiments of the present disclosure can reduce or eliminate such stagnation.

The use of the terms “a”, “an”, “the”, and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other. As used herein, the terms “about” and “substantially” are intended to include the degree of error associated with measurement of the particular quantity based upon the equipment available at the time of filing the application. For example, the terms may include a range of ±8% of a given value or other percentage change as will be appreciated by those of skill in the art for the particular measurement and/or dimensions referred to herein.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description but is only limited by the scope of the appended claims.

What is claimed is:

1. A heat exchanger comprising:
a housing;
an internal structure arranged within the housing, the internal structure defining a set of first fluid passages and a set of second fluid passages, wherein a first fluid within the set of first fluid passages is prevented from mixing with a second fluid in the set of second fluid passages;
an inlet manifold at an inlet end of the set of first fluid passages and defining an inlet plenum for receiving the first fluid, wherein the set of first fluid passages comprise openings to the inlet plenum to receive the first fluid therethrough, wherein the openings of the set of first fluid passages are defined in an inlet end face of the internal structure; and
a set of flow directors arranged on the inlet end face and configured to direct a flow of the first fluid into the openings of the set of first fluid passages, wherein each flow director defines an end face passage that is one of the second fluid passages of the set of second fluid passages.

2. The heat exchanger of claim 1, further comprising:
an outlet manifold at an outlet end of the set of first fluid passages and defining an outlet plenum for receiving the first fluid, wherein the set of first fluid passages comprise outlet openings to the outlet plenum to direct the first fluid into the outlet plenum, wherein the outlet openings of the set of first fluid passages are defined in an outlet end face of the internal structure; and
a set of outlet flow directors arranged on the outlet end face and configured to direct a flow of the first fluid into the outlet plenum, wherein each flow director defines an end face passage that is one of the second fluid passages of the set of second fluid passages.

3. The heat exchanger of claim 1, further comprising:
an inlet manifold at an inlet end of the set of second fluid passages and defining a second inlet plenum for receiving the second fluid, wherein the set of second fluid passages comprise openings to the second inlet plenum to receive the second fluid therethrough, wherein the openings of the set of second fluid passages are defined in a second inlet end face of the internal structure; and
a second set of flow directors arranged on the second inlet end face and configured to direct a flow of the second fluid into the openings of the set of second fluid passages, wherein each flow director defines an end face passage that is one of the first fluid passages of the set of first fluid passages.

4. The heat exchanger of claim 1, wherein each flow director comprises an apex and two flow control surfaces that extend from the apex to the internal structure.

5. The heat exchanger of claim 4, wherein the apex is rounded and the flow control surfaces are curved and convex as they extend to the internal structure.

6. The heat exchanger of claim 4, wherein the apex is pointed and the flow control surfaces are curved and convex as they extend to the internal structure.

7. The heat exchanger of claim 4, wherein the apex is pointed and the flow control surfaces are planar surfaces that extend to the internal structure to define a substantially triangular shape of the flow director.

8. The heat exchanger of claim 1, wherein the end face passage is similar in geometry to all other passages of the set of second fluid passages.

9. The heat exchanger of claim 1, wherein the set of first fluid passages and the set of second fluid passages are defined within an interwoven structure of the internal structure within the housing.

10. The heat exchanger of claim 1, wherein the first fluid is bleed air from an aircraft engine and the second fluid is RAM air from a RAM air duct of an aircraft.

11. A method of manufacturing a heat exchanger, the method comprising:
providing a housing;
arranging an internal structure within the housing, the internal structure defining a set of first fluid passages and a set of second fluid passages, wherein a first fluid within the set of first fluid passages is prevented from mixing with a second fluid in the set of second fluid passages;
wherein the housing defines an inlet manifold at an inlet end of the set of first fluid passages and defining an inlet plenum for receiving the first fluid, wherein the set of first fluid passages comprise openings to the inlet plenum to receive the first fluid therethrough, wherein the openings of the set of first fluid passages are defined in an inlet end face of the internal structure; and
forming a set of flow directors on the inlet end face and configured to direct a flow of the first fluid into the openings of the set of first fluid passages, wherein each flow director defines an end face passage that is one of the second fluid passages of the set of second fluid passages.

12. The method of claim 11, wherein an outlet manifold is defined by the housing at an outlet end of the set of first fluid passages and defining an outlet plenum for receiving the first fluid, wherein the set of first fluid passages comprise outlet openings to the outlet plenum to direct the first fluid into the outlet plenum, wherein the outlet openings of the set of first fluid passages are defined in an outlet end face of the internal structure; and
forming a set of outlet flow directors on the outlet end face and configured to direct a flow of the first fluid into the outlet plenum, wherein each flow director defines an end face passage that is one of the second fluid passages of the set of second fluid passages.

13. The method of claim 11, wherein an inlet manifold is defined by the housing at an inlet end of the set of second fluid passages and defining a second inlet plenum for receiving the second fluid, wherein the set of second fluid passages comprise openings to the second inlet plenum to receive the second fluid therethrough, wherein the openings of the set of second fluid passages are defined in a second inlet end face of the internal structure; and
forming a second set of flow directors on the second inlet end face and configured to direct a flow of the second fluid into the openings of the set of second fluid passages, wherein each flow director defines an end face passage that is one of the first fluid passages of the set of first fluid passages.

14. The method of claim 11, wherein each flow director comprises an apex and two flow control surfaces that extend from the apex to the internal structure.

15. The method of claim 14, wherein the apex is rounded and the flow control surfaces are curved and convex as they extend to the internal structure.

16. The method of claim 14, wherein the apex is pointed and the flow control surfaces are curved and convex as they extend to the internal structure.

17. The method of claim 14, wherein the apex is pointed and the flow control surfaces are planar surfaces that extend to the internal structure to define a substantially triangular shape of the flow director.

18. The method of claim 11, wherein the end face passage is similar in geometry to all other passages of the set of second fluid passages.

19. The method of claim 11, wherein the set of first fluid passages and the set of second fluid passages are defined within an interwoven structure of the internal structure within the housing.

20. The method of claim 11, wherein the housing and the internal structure are additively manufactured as a single structure.
